(19) United States
(12) Patent Application Publication
(10) Pub. No.: US 2018/0121366 A1
(43) Pub. Date: May 3, 2018

(54) READ/WRITE REQUEST PROCESSING METHOD AND APPARATUS

(71) Applicant: ALIBABA GROUP HOLDING LIMITED, George Town (KY)

(72) Inventor: Shikun TIAN, Hangzhou (CN)

(73) Assignee: ALIBABA GROUP HOLDING LIMITED

(21) Appl. No.: 15/801,189

(22) Filed: Nov. 1, 2017

(30) Foreign Application Priority Data
Nov. 1, 2016 (CN) 201610942888.X

(51) Int. Cl. G06F 12/1081; G06F 9/455; G06F 9/50; G06F 12/06; G06F 3/06

(52) U.S. Cl. CPC G06F 12/1081; G06F 9/45558; G06F 9/5077; G06F 2009/45583; G06F 3/0611; G06F 3/0689; G06F 2009/45579; G06F 12/063

(57) ABSTRACT

The present application discloses read/write request processing methods and apparatuses. One method disclosed herein includes: receiving an IO read/write request from a virtual machine, wherein the IO read/write request is used for requesting reading data from and/or writing data to a disk in the virtual machine; acquiring an address space obtained through mapping, and acquiring, according to the IO read/write request and the address space, an address of data stored in a physical machine; receiving, after the IO read/write request is submitted to a storage device, a processing result of the data on the storage device, wherein the storage device is an apparatus for storing the data in the physical machine; and returning the processing result to the virtual machine through the address space. Embodiments of the present application can reduce data copying and reduce IO latency.

### CROSS REFERENCE TO RELATED APPLICATION

This application claims priority to Chinese Application No. 201610942888.X, filed on Nov. 1, 2016, the entirety of which is incorporated herein by reference.

### TECHNICAL FIELD

The present application generally relates to the field of software, and in particular, to read/write request processing methods and apparatuses.

### BACKGROUND ART

In a cloud computing environment, computing resources of a data center is divided into numerous Virtual Machines (“VMs,” which are multiple instances virtualized on a server and capable of running an Operating System (OS)) by using virtualization technologies. One server can be divided into multiple VMs (VM hosts). Running and management of each VM host platform can be the same as an independent host. Each VM may independently restart and have its own root access rights, users, IP addresses, memory, processes, files, applications, system function library, and configuration files.

Users can flexibly deploy their applications on VMs, for example, web applications, social applications, game applications, financial applications, and so on. Some of these applications store important data, which requires data read/write latency to be as low as possible and requires a non-stop service and availability. To store the data, different storage manners may be selected according to different requirements. For example, some applications require high data reliability, and therefore, multiple redundant backups for data are needed so that crashing of one single server does not affect use. In this case, VM disks need to be connected to a distributed storage system. A disk can be a magnetic disk, which is a data storage medium. For another example, some applications require relatively high performance and have a relatively low Input/Output latency (“IO Latency”) requirement, wherein IO latency refers to the time it takes from sending a request to completing the request. If redundant backups are not needed for these applications, these applications can be connected to a local Redundant Array of Independent Disks (“RAID”) storage system, wherein a disk group is formed by using an array, and data can still be read when any one of the disks fails.

A data center includes clusters therein, and each server is deployed with a virtualization platform, back-end storage (such as the distributed storage and/or RAID storage mentioned above), a service management and monitoring system, and so on. These systems also consume some resources (such as CPU, memory, network, and the like), and thus a link for connecting a virtual machine disk to the back-end storage also becomes longer. These factors lead to increasing load on the server, and higher IO latency.

### SUMMARY

Embodiments of the present application provide read/write request processing methods and apparatuses. One objective of the present disclosure is to address the problem of increasing IO latency.

According to some embodiments of the present application, read/write request processing methods are provided. One method comprises: receiving an IO read/write request from a virtual machine, wherein the IO read/write request is used for requesting reading data from and/or writing data to any disk in the virtual machine; acquiring an address space obtained through mapping, and acquiring, according to the IO read/write request and the address space, an address for storing the data in a physical machine, wherein the address space is an address of the disk of the virtual machine obtained through mapping; receiving, after the IO read/write request is submitted to a storage device, a processing result of the data on the storage device, wherein the storage device is an apparatus for storing the data in the physical machine; and returning the processing result to the virtual machine through the address space.

According to some embodiments of the present application, read/write request processing methods based on a virtual machine are further provided. One method comprises: receiving an IO read/write request generated when a virtual disk on the virtual machine is read/written, wherein the virtual machine can be any virtual machine deployed on a physical machine; acquiring a mapping address of data requested by the IO read/write request, wherein the mapping address is used for mapping the IO read/write request to data in a back-end storage apparatus in the physical machine; submitting the IO read/write request to the back-end storage apparatus in the physical machine according to the mapping address to obtain a request result; receiving the request result generated when the back-end storage apparatus processes the IO read/write request; and returning the request result to the virtual machine.

According to some embodiments of the present application, rapid read/write request processing methods are further provided. One method comprises: receiving an IO read/write request generated when a virtual disk on a virtual machine is read/written, wherein the virtual machine can be any virtual machine deployed on a physical machine; and acquiring a mapping address of data requested by the IO read/write request, wherein the mapping address is used for mapping the IO read/write request to data in a back-end storage apparatus in the physical machine.

According to some embodiments of the present application, read/write request processing apparatuses is provided. One apparatus comprises: a first receiving unit configured to receive an IO read/write request from a virtual machine, wherein the IO read/write request is used for requesting reading data from and/or writing data to any disk in the virtual machine; an acquisition unit configured to acquire an address space through mapping, and acquire, according to the IO read/write request and the address space, an address for storing the data in a physical machine, wherein the address space is an address of the disk of the virtual machine obtained through mapping; a second receiving unit configured to receive, after the IO read/write request is submitted to the storage device, a processing result of the data on the storage device, wherein the storage device is an apparatus for storing the data in the physical machine; and a returning unit configured to return the processing result to the virtual machine through the address space.

According to some embodiments of the present application, read/write request processing apparatuses based on a virtual machine is further provided. One apparatus comprises: a first receiving unit configured to receive an IO read/write request generated when a virtual disk on the virtual machine is read/written, wherein the virtual machine can be any virtual machine deployed on a physical machine; an acquisition unit configured to acquire a mapping address of data requested by the IO read/write request, wherein the mapping address is used for mapping the IO read/write request to data in a back-end storage apparatus in the physical machine; a submission unit configured to submit the IO read/write request to the back-end storage apparatus in the physical machine according to the mapping address to obtain a request result; a second receiving unit configured to receive the request result generated when the back-end storage apparatus processes the IO read/write request; and a returning unit configured to return the request result to the virtual machine.

According to some embodiments of the present application, read/write request processing apparatuses are further provided. One apparatus comprises: a receiving unit configured to receive an IO read/write request generated when a virtual disk on a virtual machine is read/written, wherein the virtual machine can be any virtual machine deployed on a physical machine; and an acquisition unit configured to acquire a mapping address of data requested by the IO read/write request, wherein the mapping address is used for mapping the IO read/write request to data in a back-end storage apparatus in the physical machine.

According to some embodiments of the present application, an IO read/write request from a virtual machine is received; from an address space obtained through mapping, an address for storing data in a physical machine is acquired according to the IO read/write request and the address space; after the IO read/write request is submitted to a storage device, a processing result of the data on the storage device is received, and the processing result is returned to the virtual machine through the address space, so that the read/write request from the virtual machine is sent to the storage device.

It is appreciated that, in some embodiments of the present disclosure, the address for storing the data in the physical machine can be acquired from the address space obtained through mapping. The address space can be obtained by mapping an address space corresponding to a disk of the virtual machine. Copying from a virtualization platform to an IO access apparatus can be reduced, or copying from the IO access apparatus to the virtualization platform can be reduced. By reducing data copying, IO latency can be reduced. Therefore, embodiments of the present application can achieve effects of shortening IO links, realizing zero data copy, and reducing IO latency. Accordingly, embodiments provided by the present application can solve the technical problems of increasing IO latency.

### BRIEF DESCRIPTION OF THE DRAWINGS

The accompanying drawings illustrated herein are used for providing further illustration of some exemplary embodiments of the present application, and constitute a part of the present application. The descriptions thereof are used for explaining the present application, and do not limit the scope of to the present application.

FIG. 1 is a structural block diagram of an exemplary computer terminal for implementing some read/write request processing methods according to some embodiments of the present application;

FIG. 2 is a schematic diagram illustrating an example of VMs running on a physical machine according to some embodiments of the present application;

FIG. 3 is an interaction diagram of an exemplary read/write request processing method according to some embodiments of the present application;

FIG. 4 is a schematic diagram of an exemplary IO access apparatus according to some embodiments of the present application;

FIG. 5 is an interaction diagram of an exemplary read/write request processing method according to some embodiments of the present application;

FIG. 6 is a flowchart of an exemplary VM-based read/write request processing method according to some embodiments of the present application;

FIG. 7 is a flowchart of an exemplary rapid read/write request processing method according to some embodiments of the present application;

FIG. 8 is a structural block diagram of an exemplary read/write request processing apparatus according to some embodiments of the present application;

FIG. 9 is a structural block diagram of an exemplary VM-based read/write request processing apparatus according to some embodiments of the present application;

FIG. 10 is a structural block diagram of an exemplary rapid read/write request processing apparatus according to some embodiments of the present application; and

FIG. 11 is a structural block diagram of an exemplary computer terminal according to some embodiments of the present application.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods according to some embodiments of the present disclosure, the scope of which is defined by the appended claims.

It should be appreciated that, the terms such as “first” and “second” in the specification, claims, and the accompanying drawings of the present application are used for differentiating similar objects, and are not necessarily used for describing a specific order or sequence. It should be appreciated that, actual implementation according to the disclosure presented herein may be modified in proper situations, so that embodiments of the present application can be implemented in an order other than those illustrated or described herein. In addition, the terms “include,” “comprise” and variations thereof are intended to cover a non-exclusive inclusion. For example, a process, method, system, product, or device including a series of steps or units is not necessarily limited to the steps or units expressly listed, but can include other steps or units not expressly listed or inherent in such processes, methods, products or devices.

According to some embodiments of the present application, read/write request processing methods are provided. It should be appreciated that, steps shown in the flowcharts in the accompanying drawings may be executed in a computer system executing a set of computer-executable instructions. In addition, although a sequence may be shown in the flowcharts, in some embodiments, the shown or described steps may be performed in a sequence different from the sequence described herein.

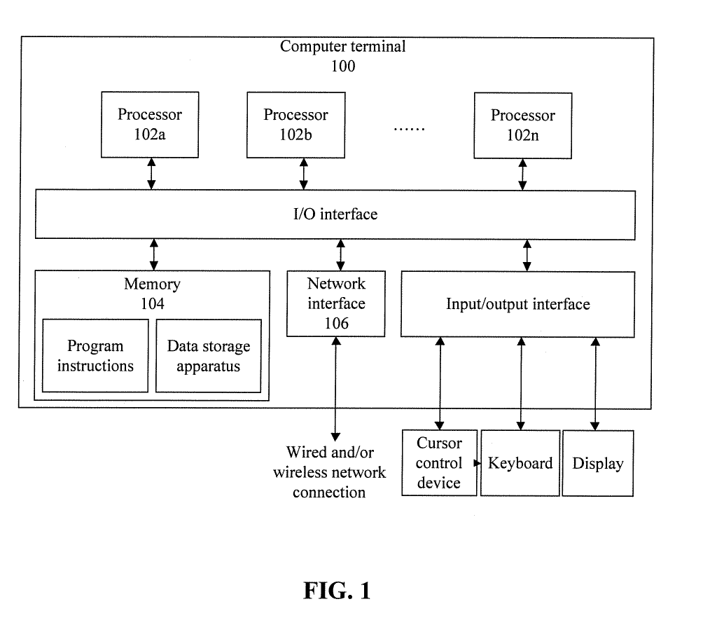

Some methods of the present application may be performed in a mobile terminal, a computer terminal, or a similar computing apparatus. FIG. 1 is a structural block diagram of an exemplary computer terminal for implementing some read/write request processing methods according to some embodiments of the present application. As shown in FIG. 1, a computer terminal 100 may include one or more processors 102 (indicated by 102a, 102b, . . . , 102n) and a memory 104 for storing data. The one or more processors 102 may include, but are not limited to, a microcontroller unit (MCU) or a programmable logical device such as field-programmable gate array (“FPGA”) and other processing apparatuses. Computer terminal 100 may further include a transmission apparatus for communication functions. In addition, computer terminal 100 may further include: a display, an input/output interface (I/O interface), a universal serial bus (USB) port (which may be included as one of ports of the I/O interface), a network interface 106, a power supply, and/or a camera.

It is appreciated that the structure shown in FIG. 1 is merely exemplary and does not constitute any limitation to the structure of electronic apparatuses that can be used for implementing embodiments of the present application. For example, computer terminal 100 may include more or fewer components than those shown in FIG. 1, or have a configuration different from that shown in FIG. 1.

It should be appreciated that, the one or more processors 102 and/or other data processing circuits described herein may be generally referred to as a data processing circuit. The data processing circuit may be all or partially embodied as software, hardware, firmware, or any combinations thereof. In addition, the data processing circuit may be a single independent processing module, which can also be all or partially integrated into any of other elements in computer terminal 10.

Memory 104 may be used for storing software programs and modules of application software. For example, memory 104 may be a storage apparatus for storing program instruction/data corresponding to the read/write request processing methods in the embodiments of the present application. Processor 102 executes various function applications and data processing by running software programs and modules stored in the memory 104, thereby implementing read/write request processing methods. Memory 104 may include a high-speed random access memory, and may further include non-volatile memories, for example, one or more magnetic storage apparatuses, flash memories, or other non-volatile solid-state memories. In some embodiments, memory 104 may further include remote memories relative to the processor 102. These remote memories may be connected to computer terminal 100 through a network. Examples of the network can include, but are not limited to, the Internet, an enterprise intranet, a local area network, a wide area network, a mobile communications network, and any combination thereof.

The transmission apparatus (e.g., network interface 106) is used for receiving or sending data via a network. Examples of the network include a wireless network provided by a communication provider of computer terminal 100. In some embodiments, the transmission apparatus can include a Network Interface Controller (NIC), which may be connected to other network devices through a base station so as to communicate with the Internet. In some embodiments, the network interface 106 may be a Radio Frequency (RF) module, which can be used for communicating with the Internet in a wireless manner.

The display may be, for example, a touchscreen liquid crystal display (LCD), which enables a user to interact with a user interface of computer terminal 100 (or a mobile device).

It should be appreciated that, in some embodiments, the computer terminal shown in FIG. 1 may include hardware elements (such as a circuit), software elements (such as computer codes stored on a computer-readable medium), or a combination of hardware elements and software elements. It should be appreciated that FIG. 1 is merely an example. Other types of components may exist in the computer terminal.

Embodiments of the present application can be applied to one or more VMs, which can run on a virtualization platform. A VM may be a software-simulated complete computer system that has complete hardware system functionality and runs in a completely isolated environment. This virtual system, by generating a new virtual mirror of an existing operating system, provides the same functionality as the real operating system. After entry into the virtual system, all operations are performed in the new independent virtual system. Software may be independently installed and run in the virtual system. The virtual system may also independently store data and have its own independent desktop, without affecting the real system on the physical machine. Moreover, the virtual system is flexible, as it allows switching between the operating system on the VM and the operating system on the physical machine. Various types of operating systems may run on the VM, for example, Windows systems, various versions of Linux systems, and MacOS systems.

Existing virtualization platforms include VMware, Virtual Box, and Virtual PC, which can virtualize multiple VMs on a physical machine whose operating system is a Windows system. Other virtualization platforms include Xen, OpenVZ, and KVM. Xen is a semi-virtualization technology, which is equivalent to running a kernel instance on its own. With Xen, kernel modules, virtual memories and IO can be freely loaded, which is reliable and predictable. Xen computations are classified into Xen+pv and Xen+hvm. The difference lies in that pv supports Linux only, while hvm supports Win systems. OpenVZ is an operating system-level virtualization technology, and is an application layer over the underlying operating system. This means it is easy to understand and has low overhead, and generally also means higher performance and more flexible configuration. KVM is similar to Xen. One advantage of KVM compared to Xen is that KVM is completely virtualized and thus there is no differentiation between pv and hvm. KVM virtualization technologies can support various Linux distributions and various Win distributions.

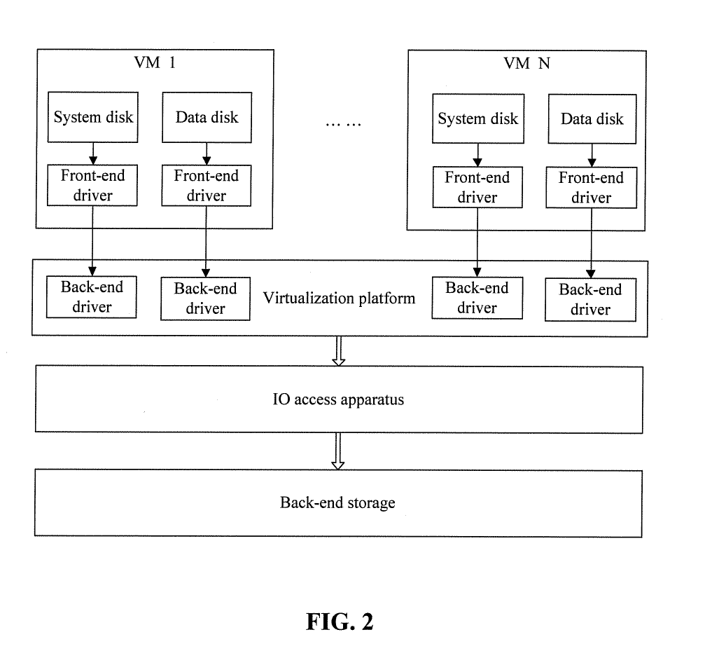

FIG. 2 is a schematic diagram illustrating an example of VMs running on a physical machine according to some embodiments of the present application. As shown in FIG. 2, a virtualization platform runs on the physical machine, and multiple VMs: VM1 to VMn, run on the virtualization platform. Each VM may have one or more disks, for example, system disks and data disks. Each disk is connected to a front-end driver. The front-end driver is a disk driver in the VM. The front-end driver is connected to a back-end driver through the virtualization platform. The virtualization platform runs on the physical machine, and is connected to a storage device (or referred to as back-end storage) through an IO access apparatus. The storage device may be, for example, a distributed storage device and/or a local RAID storage device.

Types of storage devices may be selected according to functions of different VMs. For example, some services running on virtual machines may require high data reliability. Multiple redundant backups for data may be needed so that crashing of a single VM does not affect use. In this case, VM disks may be connected to a distributed storage device. For another example, some services running on VMs require relatively high performance, while the requirement in terms of IO latency can be relatively low. In this case, if redundant backups are not needed for these services or the redundant backup problem has been solved, these services may be connected to a local RAID storage device.

Steps and units in the following embodiments may be executed in an IO access apparatus. The IO access apparatus may be a daemon process on a physical machine, which receives IO from a virtual back-end driver, performs corresponding processing, and then submits the IO to the back-end storage. In some embodiments, the IO access apparatus may be implemented by software. The method steps or modules in the following embodiments may be method steps executed by the IO access apparatus or modules included in the IO access apparatus.

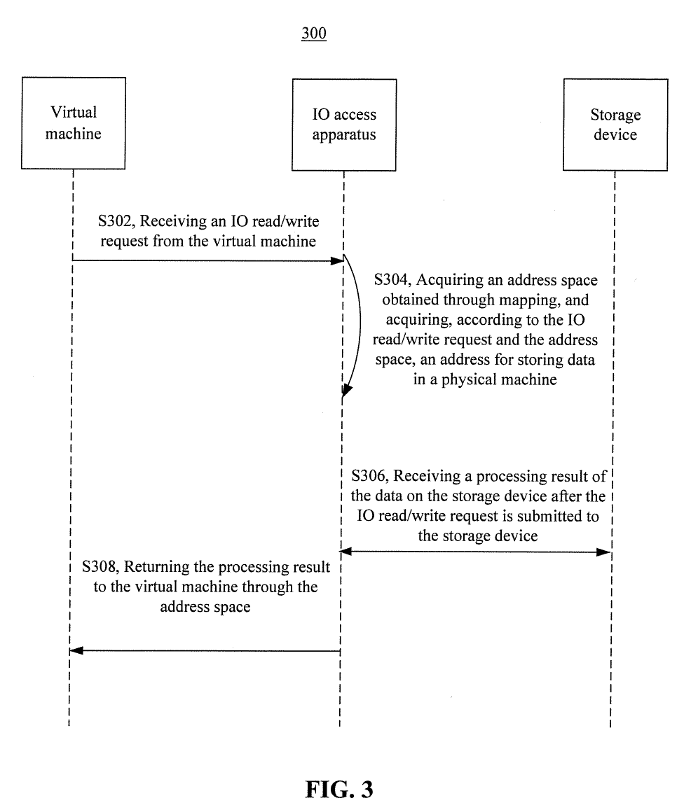

In view of the foregoing operation environment, according to some embodiments of the present application, read/write request processing methods are provided. FIG. 3 is an interaction diagram of an exemplary read/write request processing method 300 according to some embodiments of the present application. As shown in FIG. 3, the method can include the following steps:

In step S302, an IO read/write request from a VM is received by an IO access apparatus, wherein the IO read/write request is used for requesting to read data from and/or write data to any disk in the VM.

The virtualization platform may be VMware, Virtual Box, Virtual PC, Xen, OpenVZ, KVM, or the like. In this example, Xen is used for description purposes. Similar steps may be performed for processing on other virtualization platforms, and details are not described herein.

In some embodiments, multiple VMs may be virtualized on one physical machine. Applications deployed by users on these VMs may read data from and store data into disks of the VMs. A VM has at least one system disk for storing an operating system, and may have multiple data disks. The data disks can store their own service data. An IO read/write request of a disk passes through a front-end driver in the VM, and then passes through the Xen virtualization platform and reaches a back-end driver. The back-end driver forwards the IO read/write request to the IO access apparatus.

In step S304, an address space obtained through mapping is acquired at the IO access apparatus, and an address for storing the data in a physical machine is acquired according to the IO read/write request and the address space. The address space is an address of the disk of the VM obtained through mapping.

In some embodiments, after the IO read/write request from the VM is received, by mapping an address space corresponding to a disk of the VM to the IO access apparatus, an address space accessible to the IO access apparatus can be obtained. An address for storing the data in the physical machine is acquired according to the mapped address space and the IO read/write request.

In step S306, after the IO read/write request is submitted to the storage device, a processing result of the data on the storage device is received. The storage device is an apparatus for storing the data in the physical machine. In some embodiments, the storage device may include at least one of the following: a distributed storage device and a local RAID storage device.

In some embodiments, whether the 10 read/write request of the disk of the VM is submitted to a distributed storage device or a local RAID storage device may be determined according to system configurations in actual implementation. The received IO read/write request is then submitted to the storage device, and after completing the IO read/write request, the storage device returns a processing result to the IO access apparatus.

In step S308, a processing result is returned to the VM through the address space. In some embodiments, the received request result may be encapsulated as a response, i.e., the foregoing processing result, and returned to the VM.

In view of the above, it is appreciated that, according to some embodiments, an IO read/write request from a VM is received. An address space obtained through mapping is acquired. An address for storing data in a physical machine is acquired according to the IO read/write request and the address space. After the IO read/write request is submitted to a storage device, a processing result of the data on the storage device is received. The processing result is returned to the VM through the address space. Accordingly, the objective of sending the read/write request from the VM to the storage device can be achieved.

It is appreciated that, in the above-described embodiments, the address for storing the data in the physical machine can be acquired from the address space obtained through mapping, wherein the address space is obtained by mapping an address space corresponding to a disk of the VM. Copying from the virtualization platform to the IO access apparatus can be reduced, or copying from the IO access apparatus to the virtualization platform can be reduced. IO latency can be reduced by reducing data copying. Therefore, embodiments of the present application can achieve effects of shortening IO links, realizing zero data copy, and reducing IO latency. Accordingly, embodiments of the present disclosure can solve the technical problem of increasing IO latency.

In some embodiments, step S304 of acquiring an address space obtained through mapping, and acquiring, according to the IO read/write request and the address space, an address for storing the data in a physical machine may further include the following steps:

In step S3042, a context of the IO read/write request is acquired.

In step S3044, the address of the data is calculated according to the context of the IO read/write request.

In some embodiments, the address of the data may be acquired from the address space by mapping. The context of the IO read/write request may be acquired from the mapped address space. After the context of the IO read/write request is obtained, the address of the data may be calculated according to the context of the IO read/write request.

It should be appreciated that the implementation is relatively convenient when processing is performed by mapping. For example, some system calls are provided in some operating systems, and mapping can be carried out by using these system calls. The context of the IO read/write request may also be obtained in other manners, details of which are not described herein.

In some embodiments, step S3044 of calculating the address of the data according to the context of the IO read/write request may further include the following steps:

In step S30440, the address of the data is calculated according to information about the IO read/write request that is carried in the context of the IO read/write request and information about the address space. The information about the IO read/write request can include, for example, a number of the IO read/write request, a shift of the IO read/write request, a size of the IO read/write request, and a relative address of the IO read/write request. The information about the address space can include, for example, a start address of the address space and a length of the address space.

In some embodiments, after the IO read/write request is obtained, a memory address of the data may be calculated according to the context of the IO read/write request. The data can be processed according to the memory address, thereby reducing data copying and IO latency. The memory address of the data may be calculated according to information about the IO read/write request that is carried in the context of the IO read/write request and information about the mapped address space. The information about the IO read/write request can include, for example, a number of the IO read/write request, a shift of the IO read/write request, a size of the IO read/write request, and a relative address of the IO read/write request. The memory address of the data may be calculated according to the content carried in the context of the IO read/write request and the information about the address space.

In view of the above-described embodiments, it may not be necessary to, for example, copy data content of a write request from the back-end driver to the IO access apparatus, or copy data content of a read request from the IO access apparatus to the back-end driver, thus realizing zero data copy of the IO read/write request and reducing IO latency.

In some embodiments, before step S3042 of acquiring a context of the IO read/write request, the method may further include the following step:

In step S3040: when the disk of the VM is created, an address space corresponding to the disk is mapped to the physical machine to obtain the address space. Information about the address space can include, for example, the start address of the address space, and the length of the address space.

The address space of the VM may be mapped to the IO access apparatus in many cases. In some embodiments, when the disk of the VM is created, an address space corresponding to the disk of the VM may be mapped to the physical machine by using a system call such as mmap, to obtain a mapped address space. Mapping may also be performed in other cases. The mapping process is preferably performed before the IO read/write request is acquired.

In some embodiments, in step S306, submitting the IO read/write request to a storage device may further include the following steps:

In step S3062, whether the IO read/write request is allowed to be submitted to a storage device is determined according to a preset restrictive condition.

In some embodiments, multiple VMs may run on a virtualization platform of a physical machine. IO operations are performed for all these VMs, while resources on the physical machine to which these VM are attached are limited. To better utilize the resources, limiting IO read/write requests of the VMs may be considered. There can be different restrictive conditions for each VM, and this may be determined according to services running on the VMs. That is, restrictive conditions may be separately formulated for each VM. For example, the restrictive condition may be an externally set condition, for example, an input/output operations per second (IOPS) setting or a bits per second (BPS) setting for a VM disk. IOPS is the number of read/write operations performed per second. It can be used in scenarios such as databases, to measure performance of random access. BPS is a bit rate, i.e., the number of bytes of read/write operations performed per second.

Due to different importance of different services running on the VMs, a priority may further be set for each VM. IO read/write requests in a VM with a higher priority may not be limited or may have fewer limitations. That is, different restrictive conditions may be formulated with respect to different priorities.

In some embodiments, the restrictive conditions may include at least one of the following: for a disk(s) of one or more VMs, the number of processed IO read/write requests and/or the volume of processed data in a first predetermined time period does not exceed a threshold; for disks of all VMs, the number of processed IO read/write requests and/or the volume of processed data in a second predetermined time period does not exceed a threshold; priorities of the IO read/write requests; and priorities of the VMs.

In step S3064, the IO read/write request is submitted to the storage device if the determination result is yes, namely, if it is determined to allow the IO read/write request to be submitted to a storage device.

In some embodiments, whether the IO read/write request of the VM is allowed to be submitted to the storage device may be determined according to a preset restrictive condition. The IO access apparatus submits the IO read/write request to the storage device only when the determination result is yes. For example, after an IO read/write request from a VM is received, it may be determined whether the number of requests or the number of request bytes exceeds a range allowed by a current time slice. If the number of requests or the number of request bytes does not exceed a range allowed by a current time slice, it is determined that the IO read/write request is allowed to be submitted to the storage device, and the IO access apparatus may submit the IO read/write request to the storage device.

In the foregoing examples, it may be determined, according to the preset restrictive condition, whether the IO read/write request is allowed to be submitted to the storage device, thus preventing some VM disks from occupying too many resources.

In some embodiments, in step S306, submitting the IO read/write request to a storage device may further include the following step:

In step S3066, the IO read/write request is submitted to the storage device after a predetermined time if there is a determination to not allow the IO read/write request of the VM to be submitted to the storage device. In some embodiments, whether the IO read/write request is allowed to be submitted to the storage device is determined again according to the preset restrictive condition after a predetermined time.

For example, the predetermined time may be a calculated wait time for which the IO read/write request needs to wait.

In some embodiments, if the restrictive condition does not allow submission of the IO read/write request, the IO read/write request may be rejected. A prompt may further be provided indicating that resources are restricted currently. Alternatively, the IO read/write request may be submitted to the storage device again after a predetermined time. When the IO read/write request is submitted again, it may not be necessary to determine again whether the IO read/write request meets the preset restrictive condition. Alternatively, when the IO read/write request is submitted again, it may be needed to determine again whether the IO read/write request is allowed to be submitted according to the preset restrictive condition. If the submission is not allowed, the IO read/write request is submitted again after another predetermined time. For example, after an IO read/write request from a VM is received, it may be calculated whether the number of requests or the number of request bytes exceeds an allowable range of a current time slice. If the number of requests or the number of request bytes exceeds an allowable range of a current time slice, a wait time for which the request needs to wait may be calculated, and the request is put into a waiting queue. The IO read/write request can be retrieved from the waiting queue after the predetermined time and then submitted to a back-end storage request submission and callback module, so that IO performance that one disk can occupy is limited to be lower than the set IOPS and BPS.

In some embodiments, the foregoing method may further include the following step:

In step S310, during creation of the disk of the VM, a thread from a thread pool is allocated to the IO read/write request from the VM. The read/write request processing method is executed on the thread to process all IO read/write requests of the disk of the VM. The thread pool includes at least one thread, and IO read/write requests of disks of all VMs can be processed by allocating threads from the thread pool.

In some embodiments, all processing of IO read/write requests of a disk of one VM may be performed by using one thread. Further, one thread can simultaneously process IO read/write requests of disks of multiple VMs.

It should be appreciated that, a VM running on a physical machine can still use resources of the physical machine. Other than a virtualization platform, other services or applications may also run on the physical machine. To better provide resources for the VM on the physical machine, a thread may be allocated to IO read/write requests from the VM.

In some embodiments, a thread pool may be allocated to IO read/write requests of all VMs running on the physical machine. The thread pool includes at least one thread, and IO read/write requests of disks of all the VMs on the physical machine are processed in the thread pool. The IO access apparatus may allocate a thread from the thread pool for a disk of a VM. The read/write request processing method according to some embodiments can be executed on the thread to process all IO read/write requests of the disk of the VM.

In some embodiments, step S310 of executing the read/write request processing method on the thread may further include the following steps:

In step S3102, an event loop is run on the thread.

In step S3104, the read/write request processing method is executed on the thread in a manner of event triggering.

In some embodiments, the IO read/write request may be processed on the thread in various manners, for example, in a manner of event triggering. For example, an event loop may be run on the thread, and then the read/write request processing method can be executed on the thread by event triggering.

Resource sharing can be implemented by a thread pool. If the thread pool is combined with the restrictive condition of the IO read/write request, the resource utilization rate can be improved, and resources can be better managed.

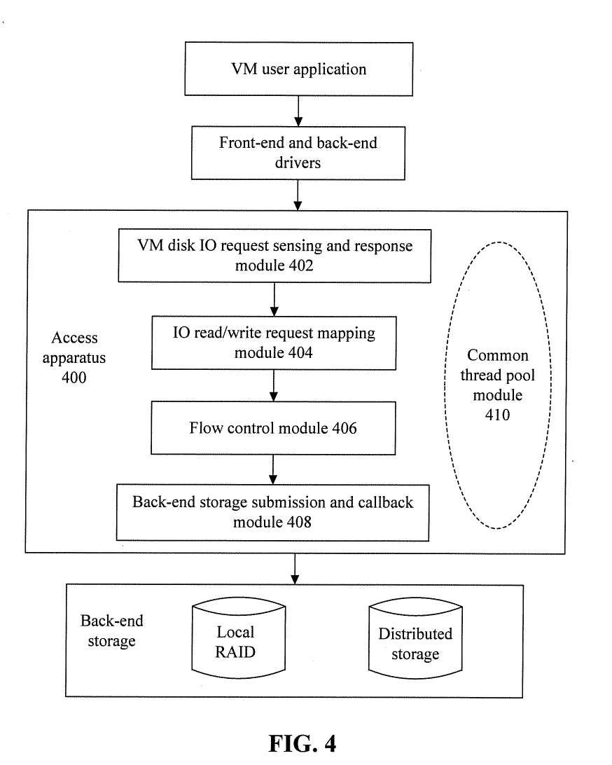

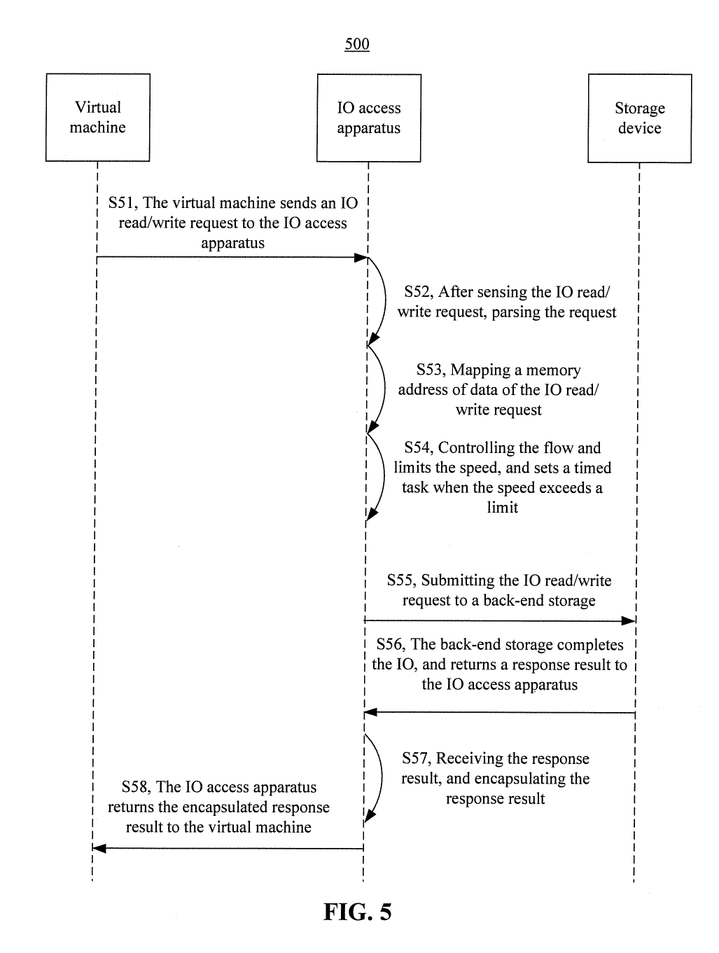

Other embodiments of the present application are described below with reference to FIG. 4 and FIG. 5.

FIG. 4 is a schematic diagram of an exemplary IO access apparatus 400 according to some embodiments of the present application. For example, IO access apparatus 400 can be the IO access apparatus of FIG. 3. As shown in FIG. 4, the access apparatus may be connected to the VM and the back-end storage, and the access apparatus may include the following modules:

a VM disk IO read/write request sensing and response module 402, which can sense, from the back-end driver of the physical machine, that a request has arrived, and can respond to the VM after the request is completed;

an IO read/write request mapping module 404, which implements memory mapping of the context of the IO read/write request and the IO data portion, so that the memory address for storing the data can be directly acquired without copying data;

a flow control module 406, which implements IO flow control for a single disk and/or multiple disks, and implements flow control upper limits of read/write IOPS and read/write BPS;

a back-end storage request submission and callback module 408, which performs request submission to the back-end storage, and subsequent processing after the request is completed in the back-end storage; and

a common thread pool module 410, which provides shared thread resources for all the foregoing modules.

The common thread pool module 410 can be a core resource of the access apparatus. All processing logic of other modules can be executed in the thread pool. The thread pool includes multiple threads, of which the quantity can vary and can be configurable. One epoll event loop is run on each thread. The epoll can sense arrival of any event, and executes callback processing logic corresponding to the event. The events can include a notification that an IO of a VM disk arrives at an access module, a flow control module timed task, completion of the IO by the back-end storage, an internal condition waiting event, and so on. All phases of IO read/write requests of disks of one VM are processed on one thread, and the thread may not be switched. One thread may simultaneously process IO read/write requests of disks of multiple VMs, and the processing does not block or interfere with each other. IOs of disks of all VMs on one physical machine are processed in this thread pool, so that CPU resources are shared.

In general, the modules/units (and any sub-modules/units) described herein can be a packaged functional hardware unit designed for use with other components (e.g., portions of an integrated circuit) and/or a part of a program (stored on a computer readable medium) that performs a particular function of related functions. The module/unit can have entry and exit points and can be written in a programming language, such as, for example, Java, Lua, C, or C++. A software module can be compiled and linked into an executable program, installed in a dynamic link library, or written in an interpreted programming language such as, for example, BASIC, Perl, or Python. It will be appreciated that software modules can be callable from other modules or from themselves, and/or can be invoked in response to detected events or interrupts. Software modules configured for execution on computing devices can be provided on a computer readable medium, such as a compact disc, digital video disc, flash drive, magnetic disc, or any other non-transitory medium, or as a digital download (and can be originally stored in a compressed or installable format that requires installation, decompression, or decryption prior to execution). Such software code can be stored, partially or fully, on a memory device of the executing computing device, for execution by the computing device. Software instructions can be embedding in firmware, such as an EPROM. It will be further appreciated that hardware modules can be comprised of connected logic units, such as gates and flip-flops, and/or can be comprised of programmable units, such as programmable gate arrays or processors.

FIG. 5 is an interaction diagram of an exemplary read/write request processing method according to some embodiments of the present application. As shown in FIG. 5, the process 500 can include the following steps:

In step S51, a VM sends an IO read/write request to an IO access apparatus (such as the IO access apparatus 400 of FIG. 4).

In step S52, the IO access apparatus, after sensing the IO read/write request, parses the request. In some embodiments, a VM disk IO read/write request sensing and response module (e.g., VM disk IO read/write request sensing and response module 402 of FIG. 4) can perform the parsing. In particular, the VM disk IO read/write request sensing and response module is an entry of the access apparatus. When the disk of the VM is created, the access apparatus may allocate a thread from the common thread pool, and register processing logic of request arrival with an epoll event loop of the thread. When an application in the VM reads or writes the disk, an IO read/write request may arrive at the physical machine via, for example, Xen front-end and back-end drivers, and trigger the epoll event of the access apparatus, thus triggering execution of the request processing logic. The VM disk IO read/write request sensing and response module parses the IO read/write request and acquires the length, shift, operation, number, relative address, and the like of the 10, and then delivers them to the memory mapping module.

In step S53, the IO access apparatus maps a memory address of data of the IO read/write request. In some embodiments, an IO read/write request mapping module (e.g., 10 read/write request mapping module 404 of FIG. 4) can perform the mapping. In particular, when the VM disk IO read/write request sensing and response module submits the request, the IO read/write request mapping module first acquires a context of the request from the mapped address space. The context can include the number, shift, and size of the request, the relative address of the requested data, and so on. The IO read/write request mapping module can calculate, according to the number of the request, the relative address, and a start address of the address space, the memory address for storing the requested data.

In step S54, the IO access apparatus controls the flow and limits the speed, and sets a timed task when the speed exceeds a limit. In some embodiments, a flow control module (e.g., flow control module 406 of FIG. 4) can perform the flow control. In particular, the flow control module may maintain information such as a time slice, the number of IOs and the number of bytes that have been submitted to the back end currently, and a waiting queue of restricted IOs. After receiving the request submitted by the IO read/write request mapping module, the flow control module calculates whether the number of requests or the number of request bytes exceeds an allowable range of the current time slice. If the number of requests or the number of request bytes exceeds an allowable range of the current time slice, the flow control module calculates a wait time that the request needs to wait for, puts the request into the waiting queue, and registers a timed task in the current thread in the thread pool of the common thread pool module. After the timed task is timed out, the flow control module retrieves the IO from the waiting queue in the current thread, and then submits the IO to the back-end storage request submission and callback module, thereby limiting IO performance that one disk can occupy to be lower than the set IOPS and BPS. The flow control module may prevent some VM disks from occupying too many resources. In some embodiments, it only uses thread resources of the common thread pool module, and does not need to use other CPU or thread resources.

In step S55, the IO access apparatus submits the IO read/write request to a back-end storage. In some embodiments, a back-end storage submission and callback module (e.g., back-end storage submission and callback module 408 of FIG. 4) can perform the submission task.

In step S56, the back-end storage completes the IO and returns a response result to the IO access apparatus.

In step S57, the IO access apparatus receives the response result, and encapsulates the response result. In some embodiments, a back-end storage submission and callback module (e.g., back-end storage submission and callback module 408 of FIG. 4) can perform the receiving task, and a VM disk IO request sensing and response module (e.g., VM disk IO request sensing and response module 402 of FIG. 4) can perform the step of encapsulating the response result.

In step S58, the IO access apparatus returns the encapsulated response result to the VM.

In some embodiments, the back-end storage submission and callback module receives the IO read/write request submitted by the flow control module and submits the request to the back-end storage. After completing the IO, the back-end storage may trigger an event loop of the thread where the disk is located, and this thread is also the thread that submits the request. Event processing logic may deliver a request result to the VM disk IO read/write request sensing and response module. VM disk IO read/write request sensing and response module encapsulates the request result into a response and returns the response to the front-end and back-end drivers.

In some existing Xen virtualization platforms and storage platform software, before being submitted to the access apparatus, the IO may be processed by a user state process after the front-end and back-end processing. The request may be copied twice in the submission and response procedures, and each disk may create an independent process. The thread may be switched in the IO processing, and resource sharing of the thread pool cannot be realized. In the access apparatus provided by some embodiments of the present disclosure, these independent processes can be eliminated, thus shortening the IO link. Zero data copy is realized by memory mapping, and multiple disks can share resources of one thread pool, thereby reducing resource consumption and improving performance. Moreover, flow control can be implemented, preventing certain disks from occupying too many resources. The flow control and speed limiting process can also share the thread pool for the IO processing.

According to the foregoing, some embodiments of the present disclosure provide an apparatus for connecting a disk of a VM to a back-end storage, which can shorten the IO link, save resources and achieve zero data copy. The apparatus can implement access of disk IOs of multiple VMs while resources such as the CPU and thread pool can be shared, thereby reducing consumption of management resources and reducing IO latency. In addition, the apparatus can further implement a flow control and speed limiting module, to prevent some devices from occupying too many CPU and thread resources and affecting IO performance of other VMs. Flow control and speed limiting can also share the thread pool for IO processing.

It should be appreciated that, for ease of description, the foregoing method embodiments are described as a series of action combinations. However, it is appreciated that the present application is not limited to the described sequence of actions, because some steps may be performed in another sequence or at the same time according to the present application. In addition, it is appreciated that the embodiments described herein are only exemplary, and the described actions and modules are not necessarily mandatory in other embodiments of the present disclosure.

Based on the foregoing descriptions, it is appreciated that the methods according to the foregoing embodiments may be implemented by software plus a necessary general hardware platform, or by hardware. However, in some cases, the former may be a preferred implementation. Based on such understanding, the technical solution of the present application may be embodied in the form of a software product. The computer software product can be stored in a storage medium (such as a ROM/RAM, a magnetic disk, or an optical disc), and includes a set of instructions for instructing a terminal device (which may be a mobile phone, a computer, a server, a network device, or the like) to preform the methods described in the embodiments of the present application.

According to some embodiments of the present application, read/write request processing methods based on a VM are further provided. It should be appreciated that, steps shown in the flowcharts in the accompanying drawings may be executed in a computer system executing a group of computer executable instructions. In addition, although a sequence may be shown in the flowcharts, the shown or described steps may be performed in a sequence different from the sequence described herein.

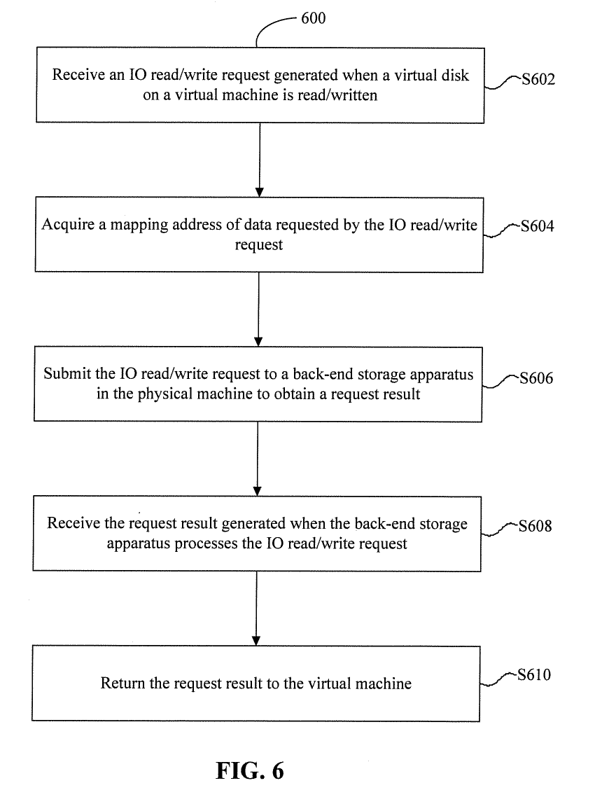

The embodiments of the present application provide read/write request processing methods based on a VM, such as the method shown in FIG. 6. FIG. 6 is a flowchart of an exemplary VM-based read/write request processing method 600 according to some embodiments of the present application. In some embodiments, method 600 can be performed by an IO access apparatus (e.g., IO access apparatus of FIG. 4). As shown in FIG. 6, the method can include the following steps:

In step S602, an IO read/write request generated when a virtual disk on the VM is read/written is received, wherein the VM can be any VM deployed on a physical machine.

In some embodiments, the foregoing virtualization platform may be VMware, Virtual Box, Virtual PC, Xen, OpenVZ, KVM, or the like. Xen is used herein as an example for description purposes. The same manner may also be used for processing on other virtualization platforms, and details are not described herein.

In some embodiments, multiple VMs may be virtualized on one physical machine. Applications deployed by users in these VMs may read data from and store data into disks of the VMs. A VM has at least one system disk for storing an operating system, and may have multiple data disks. The data disks store their own service data. The IO read/write requests of each disk pass through a front-end driver in the VM, then pass through the Xen virtualization platform, and reach a back-end driver. The back-end driver forwards the IO read/write requests to the IO access apparatus (e.g., IO access apparatus of FIG. 4). An IO request sensing and response module of the IO access apparatus can sense the IO read/write requests.

In step S604, mapping address of data requested by the IO read/write request is acquired. The mapping address is used for mapping the IO read/write request to data in a back-end storage apparatus in the physical machine.

In some embodiments, after the IO read/write request from the VM is received, an IO request mapping module may map an address space corresponding to a disk in the VM to the IO access apparatus to obtain an address space accessible to the IO access apparatus. An address for storing the data in the physical machine can be acquired according to the mapped address space and the IO read/write request.

In step S606, the IO read/write request is submitted to the back-end storage apparatus in the physical machine according to the mapping address to obtain a request result.

In some embodiments, the back-end storage apparatus may include at least one of the following: a distributed storage device and a local RAID storage device.

In step S608, the request result generated when the back-end storage apparatus processes the IO read/write request is received.

In some embodiments, whether the IO read/write request of the disk of the VM is submitted to a distributed storage or local RAID storage may be determined according to configurations. A back-end storage submission and callback module submits the received IO read/write request to the back-end storage, and after completing the IO read/write request, the back-end storage returns a processing result to the IO access apparatus.

In step S610, the request result is returned to the VM.

In some embodiments, the IO request sensing and callback module may encapsulate the received request result into a response, and return the response to the VM.

Based on the above, in some embodiments of the present application, an IO read/write request generated when a virtual disk on the VM is read/written is received. A mapping address of data requested by the IO read/write request is acquired. The IO read/write request is submitted to a back-end storage apparatus in the physical machine according to the mapping address to obtain a request result. The request result is returned to the VM, thereby achieving the objective of sending the read/write request from the VM to the storage device.

It is appreciated that the address for storing the data in the physical machine can be acquired according to the mapping address of the data requested by the IO read/write request, while specific content of the data does not need to be acquired. Copying from the virtualization platform to the IO access apparatus can be reduced, or data copying from the IO access apparatus to the virtualization platform can be reduced. IO Latency is reduced by reducing data copy links. Therefore, the solution provided in the embodiments of the present application can achieve effects of shortening an IO link, realizing zero data copy, and reducing IO latency. Therefore, embodiments according to the present application can solve the technical problem of increasing IO latency.

According to some embodiments, before step S602 of receiving an IO read/write request generated when a virtual disk on the VM is read/written, the method may further include the following step:

In step S600, an address space corresponding to the virtual disk is obtained through mapping after the virtual disk is created in the VM. A thread from a thread pool is allocated, wherein the thread is used to run an event triggered by the IO read/write request when the virtual disk is read/written.

In some embodiments, the address of the data may be acquired from an address space by mapping. When the disk of the VM is created, an address space corresponding to the disk of the VM may be mapped to the physical machine by using a system call such as mmap, to obtain a mapped address space. It is appreciated that, mapping may also be performed in other situations. In some embodiments, it is preferred that the mapping action is performed before the IO read/write request is acquired. Moreover, a thread pool may be allocated to IO read/write requests of all VMs running on the physical machine. The thread pool includes at least one thread, and IO read/write requests of disks of all the VMs on the physical machine can be processed in the thread pool.

In some embodiments, implementation can be relatively convenient when processing is performed by mapping. For example, some system calls are provided in some operating systems, and mapping can be carried out by using these system calls. It is appreciated that, context of the IO read/write request may also be obtained in other manners, details of which are not described herein.

According to some embodiments, step S604 of acquiring a mapping address of data requested by the IO read/write request may further include the following steps:

In step S6042, a start address and a length of the address space corresponding to the virtual disk are obtained through mapping.

In step S6044, information about the IO read/write request is acquired, wherein the information includes: a number of the request and a relative address of the request.

In step S6046, a memory address for storing the data requested by the IO read/write request is calculated according to the relative address of the IO read/write request and the start address of the address space.

In step S6048, the mapping address is generated according to the calculated memory address.

In some embodiments, after the IO read/write request is received, information about the IO read/write request may be read from the mapped address space, and a memory address of the data can be calculated according to the number and relative address of the IO read/write request as well as the start address of the address space. A mapping address may then be generated according to the memory address. In this way, certain data copies are avoided, thus reducing IO latency.

Through the foregoing, it is no longer necessary to copy data content of a write request from the back-end driver to the IO access apparatus or copy data content of a read request from the IO access apparatus to the back-end driver, thus realizing zero data copy of the IO read/write request and reducing IO Latency.

In some embodiments, after step S604 of acquiring a mapping address of data requested by the IO read/write request, the method may further include the following steps:

In step S612, it is calculated whether a requested volume of the IO read/write request exceeds a preset value. For example, the preset value may be an externally set value, such as an IOPS setting or a BPS setting for a VM disk.

In step S614, if the preset value is exceeded, the IO read/write request is put into a waiting queue.

In step S616, the IO read/write request is read from the waiting queue if it is detected that a timing period passes, wherein the timing period is a duration limited by a timed task registered in the thread pool.

It should be appreciated that multiple VMs may run on a virtualization platform of a physical machine. IO operations need to be performed for all these VMs, while resources on the physical machine to which these VM are attached are limited. To better utilize the resources, limiting IO read/write requests of the VMs may be considered. There may be different restrictive conditions for each VM, and this may be determined according to services running on the VMs. That is, restrictive conditions may be separately formulated for each VM.

In some embodiments, after the mapping address of the data is acquired, it may be calculated whether the number of requests or the number of requested bytes exceeds an allowable range of a current time slice. If the number of requests or the number of request bytes exceeds an allowable range of a current time slice, a wait time for which the request needs to wait is calculated, the request is put into a waiting queue. The IO is retrieved from the waiting queue after the predetermined time and then submitted to a back-end storage request submission and callback module. This way, IO performance that one disk can occupy is limited to be lower than the set IOPS and BPS.

Through the foregoing it is determined, according to the preset restrictive condition, whether the IO read/write request is allowed to be submitted to the storage device, thus preventing some VM disks from occupying too many resources.

According to some embodiments of the present application, read/write request processing methods are further provided. It should be appreciated that, steps shown in the flowcharts in the accompanying drawings may be executed in a computer system executing a group of computer executable instructions. In addition, although a sequence is shown in the flowchart, in some embodiments, the shown or described steps may be performed in a sequence different from the sequence described herein.

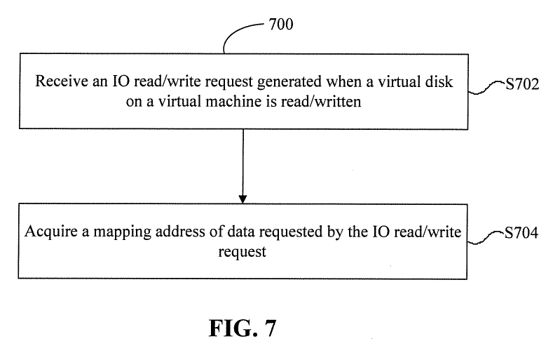

Embodiments of the present application provide read/write request processing methods based on a VM, such as the one as shown in FIG. 7. FIG. 7 is a flowchart of an exemplary rapid read/write request processing method 700 according to some embodiments of the present application. In some embodiments, method 700 can be performed by an IO access apparatus (e.g., IO access apparatus of FIG. 4). As shown in FIG. 7, the process can include the following steps:

In step S702, an IO read/write request generated when a virtual disk on a VM is read/written is received, wherein the VM can be any VM deployed on a physical machine.

In some embodiments, the foregoing virtualization platform may be VMware, Virtual Box, Virtual PC, Xen, OpenVZ, KVM, or the like. Xen is used herein as an example for description purposes. The same manner may also be used for processing on other virtualization platforms, and details are not described herein.

In some embodiments, multiple VMs may be virtualized on one physical machine. Applications deployed by users in these VMs may read data from and store data into a disk of the VMs. A VM has at least one system disk for storing an operating system, and may have multiple data disks. The data disks can store their own service data. An IO read/write request of a disk passes through a front-end driver in the VM, then passes through the Xen virtualization platform, and reaches a back-end driver. The back-end driver forwards the IO read/write request to the IO access apparatus (e.g., IO access apparatus of FIG. 4). An IO request sensing and response module of the IO access apparatus can sense the IO read/write request.

In step S704, a mapping address of data requested by the IO read/write request is acquired. The mapping address is used for mapping the IO read/write request to data in a back-end storage apparatus in the physical machine.

In some embodiments, after the IO read/write request from the VM is received, an IO request mapping module may map an address space corresponding to a disk in the VM to the IO access apparatus to obtain an address space accessible to the IO access apparatus. An address for storing the data in the physical machine is acquired according to the mapped address space and the IO read/write request.

From the above, in some embodiments of the present application, an IO read/write request generated when a virtual disk on the VM is read/written is received, and a mapping address of data requested by the IO read/write request is acquired. It is appreciated that the address for storing the data in the physical machine can be acquired according to the mapping address of the data requested by the IO read/write request, while specific content of the data does not need to be acquired. Data copies from the virtualization platform to the IO access apparatus can be reduced, or data copies from the IO access apparatus to the virtualization platform can be reduced. IO Latency can be reduced by reducing data copy links Therefore, the solution provided in the embodiments of the present application can achieve effects of shortening an IO link, realizing zero data copy, and reducing IO latency. Therefore, embodiments of the present application can solve the technical problem of increasing IO latency.

In some embodiments, after step S704 of acquiring a mapping address of data requested by the IO read/write request, the method may further include:

In step S706, the IO read/write request is submitted to the back-end storage apparatus in the physical machine according to the mapping address, to obtain a request result.

In some embodiments, the back-end storage apparatus may include at least one of the following: a distributed storage device and a local RAID storage device.

In step S708, the request result generated when the back-end storage apparatus processes the IO read/write request is received.

In some embodiments, whether the IO read/write request of the disk of the VM is submitted to a distributed storage or local RAID storage may be determined according to system configurations in actual implementation. A back-end storage submission and callback module can submit the received IO read/write request to the back-end storage. After completing the IO read/write request, the back-end storage returns a processing result to the IO access apparatus.

In step S710, the request result is returned to the VM.

In some embodiments, the IO request sensing and callback module may encapsulate the received request result into a response, and return the response to the VM.

Through step S706 to step S710 described above, the IO read/write request is submitted to the back-end storage apparatus in the physical machine according to the mapping address to obtain a request result. The request result generated when the back-end storage apparatus processes the IO read/write request is received, and the request result is returned to the VM, thereby achieving the objective of sending the read/write request from the VM to the storage device.

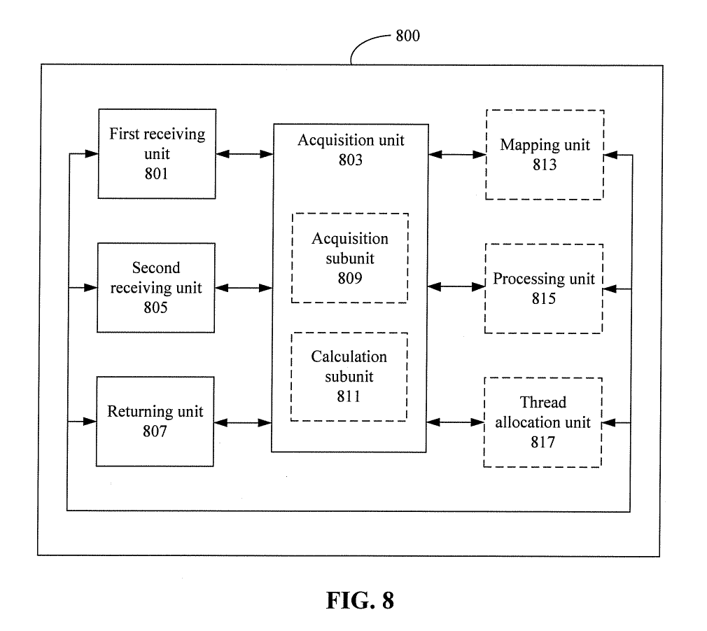

According to some embodiments, read/write request processing apparatuses for implementing the read/write request processing methods are further provided. FIG. 8 is a structural block diagram of an exemplary read/write request processing apparatus 800 according to some embodiments of the present application. As shown in FIG. 8, the apparatus 800 includes the following units: a first receiving unit 801, an acquisition unit 803, a second receiving unit 805, and a returning unit 807.

The first receiving unit 801 (which, along with other units of apparatus 800, can operate as part of computer terminal 100 of FIG. 1) is configured to receive an IO read/write request from a VM. The IO read/write request is used for requesting reading data from and/or writing data to any disk in the VM. The acquisition unit 803 is configured to acquire an address space obtained through mapping, and acquire, according to the IO read/write request and the address space, an address for storing the data in a physical machine. The address space is an address of the disk of the VM obtained through mapping. The second receiving unit 805 is configured to receive, after the IO read/write request is submitted to the storage device, a processing result of the data on the storage device. The storage device is an apparatus for storing the data in the physical machine. The returning unit 807 (which, along with other units of apparatus 800, can operate as part of computer terminal 100 of FIG. 1) is configured to return the processing result to the VM through the address space.

In some embodiments, the foregoing virtualization platform may be VMware, Virtual Box, Virtual PC, Xen, OpenVZ, KVM, or the like. Xen is used herein as an example for description purposes. The same manner may also be used for processing on other virtualization platforms, and details are not described herein.

In some embodiments, the storage device may include at least one of the following: a distributed storage device and a local RAID storage device.

It is appreciated that in some embodiments, the foregoing first receiving unit 801, acquisition unit 803, second receiving unit 805 and returning unit 807 correspond to the performing of step S302 to step S308 described above with respect to FIG. 3. The four units can implement similar steps and may apply in similar application scenarios as the corresponding steps described above with respect to FIG. 3, but are not limited to the content disclosed therein. It should be noted that in some embodiments, the units, as a part of the apparatus, may run in, for example, the computer terminal 100 provided in FIG. 1.

It can be appreciated that in some embodiments of the present application, an IO read/write request from the VM is received, an address space obtained through mapping is acquired, and an address for storing data in a physical machine is acquired according to the IO read/write request and the address space. After the IO read/write request is submitted to a storage device, a processing result of the data on the storage device is received, and the processing result is returned to the VM through the address space, thereby achieving the objective of sending the read/write request from the VM to the storage device.

It is appreciated that the address for storing the data in the physical machine can be acquired from the address space obtained through mapping, while the address space is obtained by mapping an address space corresponding to a disk of the VM. This way, data copies from the virtualization platform to the IO access apparatus can be reduced, or data copies from the IO access apparatus to the virtualization platform can be reduced. IO Latency can be reduced by reducing data copy links. Therefore, the solutions provided in some embodiments of the present application can achieve effects of shortening an IO link, realizing zero data copy, and reducing IO latency. Accordingly, the solutions of some embodiments provided in the present application can solve the technical problem of increasing IO latency.

According to the foregoing, as shown in FIG. 8, the acquisition unit 803 can include the following subunits: an acquisition subunit 809 and a calculation subunit 811.

The acquisition subunit 809 is configured to acquire a context of the IO read/write request; and the calculation subunit 811 is configured to calculate the address of the data according to the context of the IO read/write request.

It should be appreciated that the implementation can be relatively convenient when processing is performed by mapping. For example, some system calls are provided in some operating systems, and mapping can be carried out by using these system calls. It should be appreciated that the context of the IO read/write request may also be obtained in other manners, details of which are not described herein.

It should be appreciated that in some embodiments the foregoing acquisition subunit 809 and calculation subunit 811 correspond to performing of step S3042 to step S3044 described above. The two units may implement similar steps and have similar application scenarios as the corresponding steps described above, but are not limited to the content disclosed therein. It should be appreciated that in some embodiments that, the units, as a part of the apparatus, may run in, for example, the computer terminal 100 provided in FIG. 1.

According to the foregoing, the calculation subunit 811 is further configured to determine the address of the data according to information about the IO read/write request that is carried in the context of the IO read/write request and information about the address space. The information about the IO read/write request may include at least one of the following: a number of the IO read/write request, a shift of the IO read/write request, a size of the IO read/write request, and a relative address of the IO read/write request. The information about the address space may include at least one of: a start address of the address space and a length of the address space.

It should be appreciated that in some embodiments, the foregoing calculation subunit 811 corresponds to step S30440 described above. The unit can implement similar steps and may have similar application scenarios as the corresponding step described above, but is not limited to the content disclosed therein. It should be appreciated that in some embodiments, the unit, as a part of the apparatus, may run in, for example, the computer terminal 100 provided in FIG. 1.

Through the foregoing solutions, it is no longer necessary to copy data content of a write request from the back-end driver to the IO access apparatus or copy data content of a read request from the IO access apparatus to the back-end driver, thus realizing zero data copy of the IO read/write request and reducing the IO Latency.

According to the foregoing, as shown in FIG. 8, the apparatus 800 can further include a mapping unit 813. The mapping unit 813 is configured to map, when the disk of the VM is created, an address space corresponding to the disk to the physical machine to obtain the address space. The information about the address space can include at least one of the following: the start address of the address space and the length of the address space.

It should be appreciated that in some embodiments, the foregoing mapping unit 813 corresponds to step S3040 described above. The unit can implement the similar steps and may have similar application scenarios as the corresponding step described above, but is not limited to the content disclosed therein. It should be appreciated that in some embodiments, the unit, as a part of the apparatus, may run in, for example, the computer terminal 100 provided in FIG. 1.

According to the foregoing, as shown in FIG. 8, the apparatus 800 may further include a processing unit 815. The processing unit 815 is configured to determine, according to a preset restrictive condition, whether the IO read/write request is allowed to be submitted to the storage device, and submit the IO read/write request to the storage device if the determination result is to allow the IO read/write request to be submitted.

It should be appreciated that, multiple VMs may run on a virtualization platform of a physical machine. IO operations need to be performed for all these VMs, while resources on the physical machine to which these VM are attached may be limited. To better utilize the resources, limiting IO read/write requests of the VMs may be considered. There may be a different restrictive condition for each VM, and this may be determined according to services running on the VMs. That is, a restrictive condition may be separately formulated for each VM. By using the above-mentioned VM as an example, the restrictive condition may be an externally set condition, for example, an IOPS setting or a BPS setting for a VM disk. Due to different importance of different services running on the VMs, a priority may further be formulated for each VM. IO read/write requests in a VM with a high priority may not be limited or may have fewer limitations, that is, different restrictive conditions may be formulated for different priorities.

In some embodiments, the restrictive condition may include at least one of the following: for the disk of the VM, the number of processed IO read/write requests and/or the volume of processed data in a first predetermined duration do/does not exceed a threshold; for disks of all VMs, the number of processed IO read/write requests and/or the volume of processed data in a second predetermined duration do/does not exceed a threshold; a priority of the IO read/write request; and a priority of the VM.

It should be appreciated that in some embodiments, the foregoing processing unit 815 corresponds to step S3062 to step S3064 described above. The unit can implements similar steps and may have similar application scenarios as the corresponding steps described above, but is not limited to the content disclosed therein. It should be appreciated that in some embodiments, the unit, as a part of the apparatus, may run in, for example, the computer terminal 100 provided in FIG. 1.

Through the foregoing solutions, it can be determined, according to the preset restrictive condition, whether the IO read/write request is allowed to be submitted to the storage device, thus preventing some VM disks from occupying too many resources.

According to the foregoing, in some embodiments, the processing unit 815 is configured to submit the IO read/write request to the storage device after a predetermined time if the determination result is not allowing IO read/write request is allowed to be submitted; or determine again, after a predetermined time according to the preset restrictive condition, whether the IO read/write request is allowed to be submitted to the storage device.

For example, the predetermined time may be a calculated wait time for which the IO read/write request needs to wait.

It should be appreciated that in some embodiments, the foregoing processing unit 815 corresponds to step S3066 described above. The unit can implement the similar steps and may have similar application scenarios as the corresponding steps described above, but is not limited to the content disclosed therein. It should be appreciated that in some embodiments, the unit, as a part of the apparatus, may run in, for example, the computer terminal 100 provided in FIG. 1.

According to the foregoing, as shown in FIG. 8, the apparatus 800 can further include a thread allocation unit 817. The thread allocation unit 817 is configured to allocate a thread from a thread pool to the IO read/write request from the VM during creation of the disk of the VM. The read/write request processing methods can be executed on the thread to process all IO read/write requests of the disk of the VM. The thread pool includes at least one thread, and IO read/write requests of disks of all VMs can be processed by allocating a thread from the thread pool.

In some embodiments, all processing on IO read/write requests of a disk of one VM is performed by using one thread, and one thread can simultaneously process IO read/write requests of disks of multiple VMs.

It should be appreciated that, a VM running on a physical machine still needs to use resources of the physical machine. The virtualization platform, along with other services or applications, may run on the physical machine. The embodiments described herein improve how resources are provided to the VM on the physical machine.

It should be appreciated that in some embodiments, the foregoing thread allocation unit 817 corresponds to step S310 described above. The unit can implement similar steps and have similar application scenarios as the corresponding step described above, but is not limited to the content disclosed therein. It should be appreciated that in some embodiments, the unit, as a part of the apparatus, may run in, for example, the computer terminal 100 provided in FIG. 1.

In some embodiments, the units in the read/write request processing apparatus can be executed on the thread by event triggering, wherein an event loop is run on the thread.

In some embodiments, the IO read/write request may be processed on the thread in different manners, such as event triggering. For example, an event loop may be run on the thread, and then the read/write request processing methods can be executed on the thread by event triggering.

Resource sharing can be implemented by a thread pool. If the thread pool is combined with the restrictive condition of the IO read/write request, the resource utilization rate can be improved, and resources can be better managed.

According to the embodiments of the present application, read/write request processing apparatuses based on a VM are further provided.

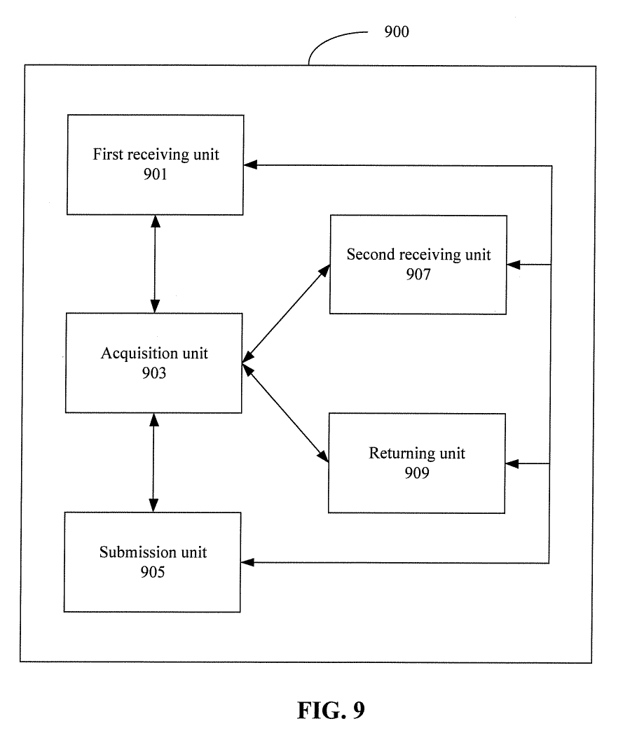

The embodiments of the present application provide read/write request processing apparatuses based on a VM, such as the one as shown in FIG. 9. FIG. 9 is a structural block diagram of an exemplary read/write request processing apparatus 900 based on a VM according to some embodiments of the present application. As shown in FIG. 9, the apparatus 900 includes: a first receiving unit 901, an acquisition unit 903, a submission unit 905, a second receiving unit 907, and a returning unit 909.

The first receiving unit 901 (which, along with other units of apparatus 900, can operate as part of computer terminal 100 of FIG. 1) is configured to receive an IO read/write request generated when a virtual disk on the VM is read/written. The VM can be any VM deployed on a physical machine. The acquisition unit 903 is configured to acquire a mapping address of data requested by the IO read/write request. The mapping address is used for mapping the IO read/write request to data in a back-end storage apparatus in the physical machine. The submission unit 905 is configured to submit the IO read/write request to the back-end storage apparatus in the physical machine according to the mapping address to obtain a request result. The second receiving unit 807 is configured to receive the request result generated when the back-end storage apparatus processes the IO read/write request. The returning unit 909 (which, along with other units of apparatus 900, can operate as part of computer terminal 100 of FIG. 1) is configured to return the request result to the VM.

In some embodiments, the foregoing virtualization platform may be VMware, Virtual Box, Virtual PC, Xen, OpenVZ, KVM, or the like. Xen is used herein as an example for description purposes. The same manner may also be used for processing on other virtualization platforms, and details are not described herein.

In some embodiments, the back-end storage apparatus may include at least one of the following: a distributed storage device and a local RAID storage device.

It should be appreciated that in some embodiments, the foregoing first receiving unit 901, acquisition unit 903, submission unit 905, second receiving unit 907 and returning unit 909 correspond to the performing of step S602 to step S610 described with respect to FIG. 6. The five units can implement similar steps and may have the same application scenarios as the corresponding steps described with respect to FIG. 6, but are not limited to the content disclosed therein. It should be appreciated that in some embodiments, the units, as a part of the apparatus, may run in, for example, the computer terminal 100 provided in FIG. 1.

In view of the above, in some embodiments of the present application, an IO read/write request generated when a virtual disk on the VM is read/written is received. A mapping address of data requested by the IO read/write request is acquired. After the IO read/write request is submitted to a storage device, the IO read/write request is submitted to a back-end storage apparatus in the physical machine according to the mapping address to obtain a request result, The request result is returned to the VM, thus achieving the objective of sending the read/write request from the VM to the storage device.

It is appreciated that, the address for storing the data in the physical machine can be acquired according to the mapping address of the data requested by the IO read/write request, while specific content of the data does not need to be acquired. Data copies from the virtualization platform to the IO access apparatus can be reduced, or data copies from the IO access apparatus to the virtualization platform can be reduced. IO Latency can be reduced by reducing data copy links. Therefore, the solutions provided in the embodiments of the present application can achieve effects of shortening an IO link, realizing zero data copy, and reducing IO latency. Accordingly, solutions provided in the embodiments of the present application can solve the technical problem of increasing IO latency.

According to the embodiments of the present application, rapid read/write request processing apparatuses for implementing rapid read/write request processing are further provided.

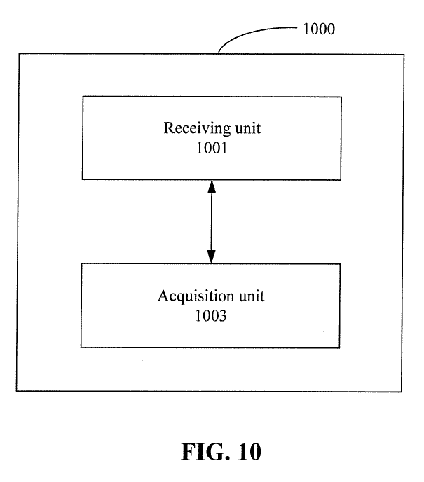

The embodiments of the present application provide a rapid read/write request processing apparatuses such as the one as shown in FIG. 10. FIG. 10 is a structural block diagram of an exemplary rapid read/write request processing apparatus 1000 according to some embodiments of the present application. As shown in FIG. 10, the apparatus 1000 includes a receiving unit 1001 and an acquisition unit 1003.

The receiving unit 1001 (which, along with other units of apparatus 1000, can operate as part of computer terminal 100 of FIG. 1) is configured to receive an IO read/write request generated when a virtual disk on a VM is read/written. The VM can be any VM deployed on a physical machine. The acquisition unit 1003 is configured to acquire a mapping address of data requested by the IO read/write request. The mapping address is used for mapping the IO read/write request to data in a back-end storage apparatus in the physical machine.

In some embodiments, the foregoing virtualization platform may be VMware, Virtual Box, Virtual PC, Xen, OpenVZ, KVM, or the like. Xen is used herein as an example for description. The same manner may also be used for processing on other virtualization platforms, and details are not described herein.

It should be appreciated that in some embodiments, the foregoing receiving unit 1001 and acquisition unit 1003 correspond to the performing of step S702 to step S704 described with respect to FIG. 7. The two units can implement similar steps and may have similar application scenarios as the corresponding steps described with respect to FIG. 7, but are not limited to the content disclosed therein. It should be appreciated that in some embodiments, the units, as a part of the apparatus, may run in, for example, the computer terminal 100 provided in FIG. 1.

In view of the above, in the solutions disclosed in some embodiments of the present application, an IO read/write request generated when a virtual disk on the VM is read/written is received; and a mapping address of data requested by the IO read/write request is acquired.

It is appreciated that, the address for storing the data in the physical machine can be acquired according to the mapping address of the data requested by the IO read/write request, while specific content of the data does not need to be acquired. Data copies from the virtualization platform to the IO access apparatus can be reduced, or data copies from the IO access apparatus to the virtualization platform can be reduced. IO Latency can be reduced by reducing data copy links Therefore, the solutions provided in the embodiments of the present application can achieve effects of shortening an IO link, realizing zero data copy, and reducing IO latency.

Accordingly, the solutions of embodiments provided in the present application can solve the technical problem of increasing IO latency.

The embodiments of the present application further provide computer terminals, or referred to as computing devices. The computer terminal may be any computer terminal device in a computer terminal group. In some embodiments, the computer terminal may also be replaced with a terminal device such as a mobile terminal.

In some embodiments, the computer terminal may be located on at least one network device among multiple network devices of a computer network.

In some embodiments, the computer terminal may execute program code of the following steps in the following method: receiving an IO read/write request from a VM, wherein the IO read/write request is used for requesting reading data from and/or writing data to any disk in the VM; acquiring an address space obtained through mapping, and acquiring, according to the IO read/write request and the address space, an address for storing the data in a physical machine, wherein the address space is an address of the disk of the VM obtained through mapping; receiving, after the IO read/write request is submitted to a storage device, a processing result of the data on the storage device, wherein the storage device is an apparatus for storing the data in the physical machine; and returning the processing result to the VM through the address space.

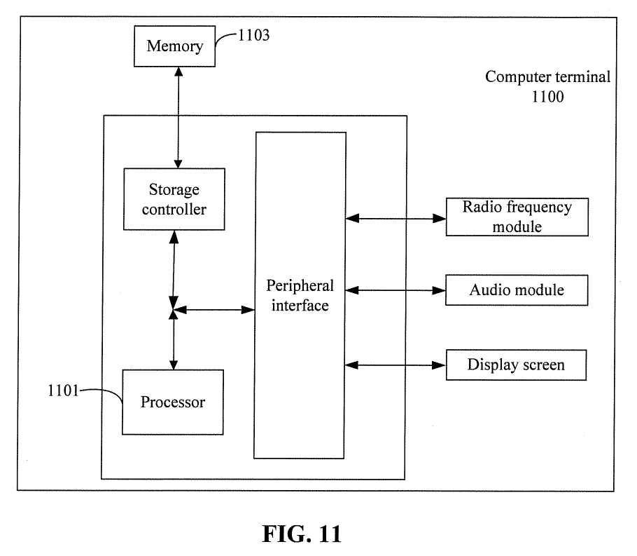

FIG. 11 is a structural block diagram of an exemplary computer terminal according to some embodiments of the present application. As shown in FIG. 11, the computer terminal 1100 may include: one or more (only one is shown in the figure) processors 1101, and a memory 1103.

The memory 1103 may be used for storing software programs and units, for example, program instructions/units corresponding to the read/write request processing methods and apparatuses described with respect to the embodiments of the present application. The processor 1101 executes various function applications and data processing by running the software programs and units stored in the memory 1103, thus implementing the foregoing read/write request processing methods. The memory 1103 may include a high-speed random access memory, and may further include a non-volatile memory, for example, one or more magnetic storage apparatuses, a flash memory, or other non-volatile solid-state memories. In some examples, the memory 1103 may further include remote memories relative to the processor. These remote memories may be connected to the computer terminal through a network. Examples of the network include, but are not limited to, the Internet, an enterprise intranet, a local area network, a mobile communications network, and a combination thereof.

The processor 1101 may call, by using a transmission apparatus, the information and applications stored in the memory, to execute the following steps: receiving an IO read/write request from a VM, wherein the IO read/write request is used for requesting reading data from and/or writing data to any disk in the VM; acquiring an address space obtained through mapping, and acquiring, according to the IO read/write request and the address space, an address for storing the data in a physical machine, wherein the address space is an address of the disk of the VM obtained through mapping; receiving, after the IO read/write request is submitted to a storage device, a processing result of the data on the storage device, wherein the storage device is an apparatus for storing the data in the physical machine; and returning the processing result to the VM through the address space.

In some embodiments, the processor 1101 may further execute program code to perform the following steps: acquiring a context of the IO read/write request; and calculating the address of the data according to the context of the IO read/write request.

In some embodiments, the processor may further execute program code to perform the following step: calculating the address of the data according to information about the IO read/write request that is carried in the context of the IO read/write request and information about the address space. The information about the IO read/write request can include at least one of the following: a number of the IO read/write request, a shift of the IO read/write request, a size of the IO read/write request, and a relative address of the IO read/write request. The information about the address space can include at least one of: a start address of the address space and a length of the address space.

In some embodiments, the processor 1101 may further execute program code to perform the following step: before the context of the IO read/write request is acquired, mapping, when the disk of the VM is created, an address space corresponding to the disk to the physical machine to obtain the address space. The information about the address space can include at least one of the following: the start address of the address space and the length of the address space.

In some embodiments, the processor 1101 may further execute program code to perform the following steps: determining, according to a preset restrictive condition, whether it is allowed to submit the IO read/write request to the storage device; and submitting the IO read/write request to the storage device if the determination result is to allow the IO read/write request to be submitted.

In some embodiments, the processor 1101 may further execute program code to perform the following step: submitting the IO read/write request to the storage device after a predetermined time if the determination result is not allowing the IO read/write request to be submitted; or determining again, after a predetermined time according to the preset restrictive condition, whether it is allowed to submit the IO read/write request to the storage device.

In some embodiments, the processor 1101 may further execute program the perform the following: the restrictive condition includes at least one of the following: for the disk of the VM, the number of processed IO read/write requests and/or the volume of processed data in a first predetermined duration do/does not exceed a threshold; for disks of all VMs, the number of processed IO read/write requests and/or the volume of processed data in a second predetermined duration do/does not exceed a threshold; a priority of the IO read/write request; and a priority of the VM.

In some embodiments, the processor 1101 may further execute program code to perform the following step: allocating a thread from a thread pool to the IO read/write request from the VM during creation of the disk of the VM. The read/write request processing method can be executed on the thread to process all IO read/write requests of the disk of the VM. The thread pool includes at least one thread, and IO read/write requests of disks of all VMs can be processed by allocating a thread from the thread pool.

In some embodiments, the processor 1101 may further execute program code to perform the following step: all processing on IO read/write requests of a disk of one VM is performed by using one thread, and one thread can simultaneously process IO read/write requests of disks of multiple VMs.

In some embodiments, the processor 1101 may further execute program code to perform the following steps: running an event loop on the thread; and executing the read/write request processing method on the thread by event triggering.

In view of the above, in some embodiments: an IO read/write request from the VM is received; an address space obtained through mapping is acquired; an address for storing data in a physical machine is acquired according to the IO read/write request and the address space; after the IO read/write request is submitted to a storage device, a processing result of the data on the storage device is received; and the processing result is returned to the VM through the address space, thus achieving the objective of sending the read/write request from the VM to the storage device.

It is appreciated that, the address for storing the data in the physical machine can be acquired from the address space obtained through mapping, while the address space is obtained by mapping an address space corresponding to a disk of the VM. This way, data copies from the virtualization platform to the IO access apparatus can be reduced, or data copies from the IO access apparatus to the virtualization platform can be reduced. IO Latency can be reduced by reducing data copy links. Therefore, the solutions provided in the embodiments of the present application can achieve effects of shortening an IO link, realizing zero data copy, and reducing IO latency.

Therefore, the solutions provided by embodiments of the present disclosure can solve the technical problem of increasing IO latency.

It should be appreciated that, the structure shown in FIG. 11 is only schematic and exemplary. The computer terminal 1100 may be a smart phone (for example, an Android phone, an iOS phone, and so on), a tablet computer, a palmtop computer, and a Mobile Internet Device (MID), a PAD, and other terminal devices. FIG. 11 does not limit the structure of the foregoing electronic apparatus. For example, the computer terminal 1100 may include more or fewer components (for example, a network interface, a display apparatus, and so on) than those shown in FIG. 11, or have a configuration different from that shown in FIG. 11.

It should be appreciated that some of the steps of the methods in the foregoing embodiments may be implemented by a program executable by hardware related to a terminal device. The program may be stored in a non-transitory computer readable medium. The non-transitory computer readable medium may include: a flash disk, a Read-Only Memory (ROM), a Random Access Memory (RAM), a magnetic disk, an optic disc, and the like.

The embodiments of the present application further provide storage media. In some embodiments, the storage medium may be used for storing program code for executing the methods provided in the embodiments of the present disclosure, such as those described with respect to FIG. 3.

In some embodiments, the storage medium may be located in any computer terminal in a computer terminal group in a computer network, or may be located in any mobile terminal in a mobile terminal group.

In some embodiments, the storage medium may be configured to store program code for executing the following steps: receiving an IO read/write request from a VM, wherein the IO read/write request is used for requesting reading data from and/or writing data to any disk in the VM; acquiring an address space obtained through mapping, and acquiring, according to the IO read/write request and the address space, an address for storing the data in a physical machine, wherein the address space is an address of the disk of the VM obtained through mapping; receiving, after the IO read/write request is submitted to a storage device, a processing result of the data on the storage device, wherein the storage device is an apparatus for storing the data in the physical machine; and returning the processing result to the VM through the address space.

In some embodiments, the storage medium may be further configured to store program code for executing the following steps: acquiring a context of the IO read/write request; and calculating the address of the data according to the context of the IO read/write request.

In some embodiments, the storage medium may be further configured to store program code for executing the following steps: calculating the address of the data according to information about the IO read/write request that is carried in the context of the IO read/write request and information about the address space. The information about the IO read/write request can include at least one of the following: a number of the IO read/write request, a shift of the IO read/write request, a size of the IO read/write request, and a relative address of the IO read/write request. The information about the address space can include at least one of: a start address of the address space and a length of the address space.

In some embodiments, the storage medium may be further configured to store program code for executing the following steps before the context of the IO read/write request is acquired: mapping, when the disk of the VM is created, an address space corresponding to the disk to the physical machine to obtain the address space. The information about the address space can include at least one of the following: the start address of the address space and the length of the address space.

In some embodiments, the storage medium may be further configured to store program code for executing the following steps: determining, according to a preset restrictive condition, whether the IO read/write request is allowed to be submitted to the storage device; and submitting the IO read/write request to the storage device if the determination result is to allow the IO read/write request to be submitted.

In some embodiments, the storage medium may be further configured to store program code for executing the following steps: submitting the IO read/write request to the storage device after a predetermined time if the determination result is not allowing the IO read/write request to be submitted; or determining again, after a predetermined time according to the preset restrictive condition, whether it is allowed to submit the IO read/write request to the storage device.

In some embodiments, the storage medium may be further configured to store program code for executing the following steps: the restrictive condition includes at least one of the following: for the disk of the VM, the number of processed IO read/write requests and/or the volume of processed data in a first predetermined duration do/does not exceed a threshold; for disks of all VMs, the number of processed IO read/write requests and/or the volume of processed data in a second predetermined duration do/does not exceed a threshold; a priority of the IO read/write request; and a priority of the VM.

In some embodiments, the storage medium may be further configured to store program code for executing the following steps: allocating a thread from a thread pool to the IO read/write request from the VM during creation of the disk of the VM. The read/write request processing method can be executed on the thread to process all IO read/write requests of the disk of the VM. The thread pool includes at least one thread, and IO read/write requests of disks of all VMs can be processed by allocating a thread from the thread pool.

In some embodiments, the storage medium may be further configured to store program code for executing the following steps: all processing on IO read/write requests of a disk of one VM is performed by using one thread, and one thread can simultaneously process IO read/write requests of disks of multiple VMs.

In some embodiments, the storage medium may be further configured to store program code for executing the following steps: running an event loop on the thread; and executing the read/write request processing method on the thread by event triggering.

The serial numbers of the foregoing embodiments of the present application are merely used for description, and do not imply the preference among the embodiments.

In the foregoing embodiments of the present application, the description of each embodiment may focus on different aspects of the present disclosure. For a part that is not described in detail in an embodiment, reference may be made to related descriptions in other embodiments.

In the several embodiments provided in the present application, it should be appreciated that, the disclosed technical content may be implemented in other manners. The apparatus embodiments described above are merely schematic and exemplary. For example, the unit division can be merely logical function division, and there may be other division manners in actual implementation. For example, multiple units or components may be combined or integrated into another system, or some features may be omitted or not performed. In addition, the displayed or discussed mutual couplings or direct couplings or communication connections may be implemented by using some interfaces. The indirect couplings or communication connections between units or modules may be implemented in an electronic form or other forms.

The units described as separate parts may or may not be physically separate, and the parts displayed as units may or may not be physical units. That is, they may be located in one position, or may be distributed on a plurality of network units. Some or all of the units therein may be selected according to actual needs to achieve the objectives of the solution of the embodiments.

In addition, functional units in the embodiments of the present application may be integrated into one or more processing units, or each of the units may exist alone physically, or two or more units are integrated into one unit. The integrated unit may be implemented in the form of hardware, or may be implemented in the form of a software function unit.

The integrated unit implemented in the form of a software functional unit may be stored in a computer-readable storage medium. The software functional unit can be stored in a storage medium, which includes a set of instructions for instructing a computer device (which may be a personal computer, a server, a network device, or the like) or a processor to perform a part of the steps of the methods described in the embodiments of the present application. The foregoing storage medium may include, for example, any medium that can store a program code, such as a USB flash disk, a removable hard disk, a Read-Only Memory (ROM), a Random Access Memory (RAM), a magnetic disk, or an optical disc. The storage medium can be a non-transitory computer readable medium. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

Described above are merely exemplary implementations of the present application. It should be appreciated that, those of ordinary skill in the art may further make certain modifications without departing from the principles of the present application. These modifications shall all fall within the protection scope of the present application.

1. A read/write request processing method based on a virtual machine, comprising:
receiving an IO read/write request generated when a disk of the virtual machine is read/written, wherein the virtual machine is a virtual machine deployed on a physical machine from a virtual machine;
acquiring a mapping address of data requested by the IO read/write request, wherein the mapping address is used for mapping the IO read/write request to data in a storage apparatus in the physical machine;
submitting the IO read/write request to the storage apparatus in the physical machine according to the mapping address to obtain a request result;
receiving the request result generated when the storage apparatus processes the IO read/write request; and
returning the request result to the virtual machine.

2. The method according to claim 1, wherein acquiring the mapping address of data requested by the IO read/write request comprises:
acquiring a context of the IO read/write request; and
determining the address of the data according to the context of the IO read/write request.

3. The method according to claim 2, wherein determining the address of the data according to the context of the IO read/write request comprises:
determining the address of the data according to information about the IO read/write request and information about an address space, wherein the address space is an address of the disk of the virtual machine obtained through mapping,
wherein the information about the IO read/write request includes at least one of: a number of the IO read/write request, a shift of the IO read/write request, a size of the IO read/write request, and a relative address of the IO read/write request, and
wherein the information about the address space includes at least one of: a start address of the address space, and a length of the address space.

4. The method according to claim 2, wherein before acquiring a context of the IO read/write request, the method further comprises:
mapping, when the disk of the virtual machine is created, an address space corresponding to the disk to the physical machine, to obtain the address space.

5. The method according to claim 1, wherein submitting the IO read/write request to the storage apparatus comprises:
determining, according to a preset restrictive condition, whether the IO read/write request is allowed to be submitted to the storage apparatus; and
submitting the IO read/write request to the storage apparatus device when it is determined that the IO read/write request is allowed to be submitted to the storage apparatus.

6. The method according to claim 5, wherein submitting the IO read/write request to the storage apparatus further comprises:
submitting the IO read/write request to the storage apparatus after a predetermined time, when it is determined that the IO read/write request is not allowed to be submitted to the storage apparatus; or
determining, after a predetermined time according to the preset restrictive condition, whether the IO read/write request is allowed to be submitted to the storage apparatus.

7. The method according to claim 5, wherein the restrictive condition includes at least one of:
for the disk of the virtual machine, at least one of the number of processed IO read/write requests and the volume of processed data in a first predetermined duration does not exceed a threshold;
for disks of all virtual machines, at least one of the number of processed IO read/write requests and the volume of processed data in a second predetermined duration does not exceed a threshold;
a priority of the IO read/write request; and
a priority of the virtual machine.

8. The method according to claim 1, further comprising:
allocating a thread from a thread pool to the IO read/write request during creation of the disk of the virtual machine,
wherein the read/write request processing method is executed on the thread to process all IO read/write requests of the disk of the virtual machine, and
wherein the thread pool includes at least one thread.

9. The method according to claim 8, wherein the thread simultaneously processes IO read/write requests of disks of a plurality of virtual machines.

10. The method according to claim 8, wherein executing the read/write request processing method on the thread comprises:
running an event loop on the thread; and
executing the read/write request processing method on the thread by event triggering.

11. The method according to claim 1, wherein the storage apparatus comprises at least one of the following: a distributed storage device, and a local redundant array of independent disks (RAID) storage device.

12. (canceled)

13. The method according to claim 1, wherein before the IO read/write request is generated when a disk on the virtual machine is read/written, the method further comprises:
obtaining an address space corresponding to the disk through mapping; and
allocating a thread from a thread pool, wherein the thread is used to run an event triggered by the IO read/write request when the disk is read/written.

14. The method according to claim 13, wherein acquiring a mapping address of data requested by the IO read/write request comprises:
obtaining a start address of the address space corresponding to the virtual disk through mapping;
acquiring information about the IO read/write request, wherein the information includes a relative address of the request;
determining, according to the relative address of the IO read/write request and the start address of the address space, a memory address for storing the data requested by the IO read/write request; and
generating the mapping address according to the determined memory address.

15. The method according to claim 13, wherein after acquiring a mapping address of data requested by the IO read/write request, the method further comprises:
determining whether an IO read/write request volume of the exceeds a preset value;
in response to the IO read/write request volume of the exceeding a preset value, putting the IO read/write request into a waiting queue; and
reading the IO read/write request from the waiting queue after a timing period, wherein the timing period is a duration limited by a timed task registered in the thread pool.

16-19. (canceled)

20. A read/write request processing apparatus based on a virtual machine, comprising:
a first receiving unit configured to receive an IO read/write request generated when a virtual disk on the virtual machine is read/written, wherein the virtual machine is a virtual machine deployed on a physical machine;
an acquisition unit configured to acquire a mapping address of data requested by the IO read/write request, wherein the mapping address is used for mapping the IO read/write request to data in a storage apparatus of the physical machine;
a submission unit configured to submit the IO read/write request to the storage apparatus in the physical machine according to the mapping address to obtain a request result;
a second receiving unit configured to receive the request result generated when the storage apparatus processes the IO read/write request; and
a returning unit configured to return the request result to the virtual machine.

21. (canceled)

22. A non-transitory computer readable medium that stores a set of instructions that is executable by at least one processor of a read/write request processing apparatus to cause the read/write request processing apparatus to perform a method for read/write request processing based on a virtual machine, the method comprising:
receiving an IO read/write request generated when a disk of the virtual machine is read/written, wherein the virtual machine is a virtual machine deployed on a physical machine;
acquiring a mapping address of data requested by the IO read/write request, wherein the mapping address is used for mapping the IO read/write request to data in a storage apparatus in the physical machine;
submitting the IO read/write request to the storage apparatus in the physical machine according to the mapping address to obtain a request result;
receiving the request result generated when the storage apparatus processes the IO read/write request; and
returning the request result to the virtual machine.

23. The non-transitory computer readable medium according to claim 22, wherein acquiring a mapping address of data requested by the IO read/write request, comprises:
acquiring a context of the IO read/write request; and
determining the address of the data according to the context of the IO read/write request.

24. The non-transitory computer readable medium according to claim 22, wherein determining the address of the data according to the context of the IO read/write request comprises:
determining the address of the data according to information about the IO read/write request and information about an address space, wherein the address space is an address of the disk of the virtual machine obtained through mapping,
wherein the information about the IO read/write request includes at least one of: a number of the IO read/write request, a shift of the IO read/write request, a size of the IO read/write request, and a relative address of the IO read/write request, and
wherein the information about the address space includes at least one of: a start address of the address space, and a length of the address space.

25. The non-transitory computer readable medium according to claim 23, wherein before acquiring a context of the IO read/write request, the set of instructions that is executable by the at least one processor of the read/write request processing apparatus causes the read/write request processing apparatus to further perform:
mapping, when the disk of the virtual machine is created, an address space corresponding to the disk to the physical machine, to obtain the address space.

26. The non-transitory computer readable medium according to claim 22, wherein submitting the IO read/write request to the storage apparatus comprises:
determining, according to a preset restrictive condition, whether the IO read/write request is allowed to be submitted to the storage apparatus; and
submitting the IO read/write request to the storage apparatus device when it is determined that the IO read/write request is allowed to be submitted to the storage apparatus.

27. The non-transitory computer readable medium according to claim 26, wherein submitting the IO read/write request to the storage apparatus further comprises:
submitting the IO read/write request to the storage apparatus after a predetermined time, when it is determined that the IO read/write request is not allowed to be submitted to the storage apparatus; or
determining, after a predetermined time according to the preset restrictive condition, whether the IO read/write request is allowed to be submitted to the storage apparatus.

28. The non-transitory computer readable medium according to claim 26, wherein the restrictive condition includes at least one of:
for the disk of the virtual machine, at least one of the number of processed IO read/write requests and the volume of processed data in a first predetermined duration does not exceed a threshold;
for disks of all virtual machines, at least one of the number of processed IO read/write requests and the volume of processed data in a second predetermined duration does not exceed a threshold;
a priority of the IO read/write request; and
a priority of the virtual machine.

29. The non-transitory computer readable medium according to claim 22, wherein the set of instructions that is executable by the at least one processor of the read/write request processing apparatus causes the read/write request processing apparatus to further perform:
allocating a thread from a thread pool to the IO read/write request during creation of the disk of the virtual machine,
wherein the read/write request processing method is executed on the thread to process all IO read/write requests of the disk of the virtual machine, and
wherein the thread pool includes at least one thread.

30. The non-transitory computer readable medium according to claim 29, wherein the thread simultaneously processes IO read/write requests of disks of a plurality of virtual machines.

31. The non-transitory computer readable medium according to claim 29, wherein executing the read/write request processing method on the thread comprises:
running an event loop on the thread; and
executing the read/write request processing method on the thread by event triggering.

32. The non-transitory computer readable medium according to claim 22, wherein the storage apparatus comprises at least one of the following: a distributed storage device, and a local redundant array of independent disks (RAID) storage device.

33. (canceled)

34. The non-transitory computer readable medium according to claim 22, wherein before the IO read/write request is generated when a virtual disk on the virtual machine is read/written, the set of instructions that is executable by the at least one processor of the read/write request processing apparatus causes the read/write request processing apparatus to further perform:
obtaining an address space corresponding to the disk through mapping; and
allocating a thread from a thread pool, wherein the thread is used to run an event triggered by the IO read/write request when the disk is read/written.

35. The non-transitory computer readable medium according to claim 34, wherein the acquiring a mapping address of data requested by the IO read/write request comprises:
obtaining a start address of the address space corresponding to the disk through mapping;
acquiring information about the IO read/write request, wherein the information includes a relative address of the request;
determining, according to the relative address of the IO read/write request and the start address of the address space, a memory address for storing the data requested by the IO read/write request; and
generating the mapping address according to the determined memory address.

36. The non-transitory computer readable medium according to claim 34, wherein after acquiring a mapping address of data requested by the IO read/write request, the set of instructions that is executable by the at least one processor of the read/write request processing apparatus causes the read/write request processing apparatus to further perform:
determining whether an IO read/write request volume of the exceeds a preset value;
in response to the IO read/write request volume of the exceeding a preset value, putting the IO read/write request into a waiting queue; and
reading the IO read/write request from the waiting queue after a timing period, wherein the timing period is a duration limited by a timed task registered in the thread pool.

37-39. (canceled)
